(19) United States
(12) Patent Application Publication
(10) Pub. No.: US 2016/0171106 A1
(43) Pub. Date: Jun. 16, 2016

(54) WEBPAGE CONTENT STORAGE AND REVIEW

(71) Applicant: Microsoft Corporation, Redmond, WA (US)

(72) Inventors: Ruihua Song, Beijing (CN); Junjie Li, Quanzhou (CN); Xing Xie, Beijing (CN); Xin Liu, Redmond, WA (US)

(21) Appl. No.: 14/566,991

(22) Filed: Dec. 11, 2014

(51) Int. Cl. G06F 17/30

(52) U.S. Cl. CPC G06F 17/30867; G06F 17/30893

(57) ABSTRACT

Webpage content may be identified and stored for later review by capturing at least part of an image of the webpage content, and sending the image to a remote device. The remote device may recognize text included in the image and may form a plurality of text groups based on the text. The remote device may also generate a plurality of searches using the text. The remote device may also generate a content item using content that is available online or through a private network, and that is identified in one of the searches. The content item may then be stored and made available for subsequent review.

### BACKGROUND

Modern cellular phones, notebook computers, tablets, and other electronic devices enable users to consume a wide array of information available on the Internet through their respective electronic devices. For example, such devices may operate a variety of different applications including news applications, blog applications, social media applications, mixed applications, search engines, and other applications through which the user may consume content originating from different webpages or other sources.

### SUMMARY

This disclosure describes, in part, techniques for identifying webpage content for later recall and rendering. Example methods of the present disclosure may include, among other things, rendering webpage content on a display, and capturing an image, such as a screenshot, of at least a portion of the rendered content. Such methods may also include sending and/or otherwise providing the captured image to one or more remote devices. Such remote devices may include, for example, one or more cloud-based service providers, remotely-located (e.g., cloud-based) servers, and/or other devices operably connected to the electronic device via the Internet or other networks. At least partially in response to receiving the captured image, the remote device may process the received image using optical character recognition or other techniques to recognize text, symbols, characters, and the like included in the captured image.

In some examples, the remote device may also form a plurality of text groups based on the text included in the captured image. For instance, the remote device may merge, separate and/or otherwise group adjacent lines and/or other portions of the recognized text according to one or more predetermined text grouping rules. The remote device may also generate a plurality of search queries based on the recognized text. The searches may each yield respective search results that include a plurality of webpage links. The remote device may also identify at least one of the webpage links as being indicative of a webpage or other forms of electronic documents (e.g., PDF, slideshows, manuals, medical records, etc.) that include the original webpage content rendered on the display and consumed by the user. In some examples, the remote device may also generate a content item using content from the identified webpage and/or other identified electronic documents. Once such a content item has been generated, the remote device may send and/or otherwise provide the content item, and/or a link to the content item, to the electronic device in response to a request received via the electronic device.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example architecture including example electronic devices coupled to a service provider via a network.

FIG. 2 illustrates example components of an electronic device.

FIG. 3 shows a flow diagram illustrating an example method of identifying webpage content for later recall and rendering.

FIG. 4 illustrates example webpage content rendered on an electronic device.

FIG. 5A illustrates example recognized text and example text groups.

FIG. 5B illustrates recognized text and additional example text groups.

FIG. 6A illustrates example search queries generated based on the example recognized text of FIG. 5A.

FIG. 6B illustrates additional example search queries generated based on the recognized text of FIG. 5B.

FIG. 7 illustrates example search results yielded using various search queries shown in FIG. 6A.

FIG. 8 illustrates an example webpage corresponding to a webpage link identified in the search results of FIG. 7.

FIG. 9 illustrates an example content item generated by extracting content from the webpage shown in FIG. 8.

### DETAILED DESCRIPTION

The present disclosure describes, among other things, techniques for recalling and rendering webpage content. For example, users of electronic devices may consume webpage content using a variety of different applications. Such applications may enable the user to consume webpage content from a wide array of disparate sources, and such sources may have differing formats, protocols, and/or other configurations. For example, various content sources may employ formats presenting webpage content to the user in the form of a blog, message board, newspaper, journal, or magazine articles, book format, eBook format, graphical format (e.g., a comic book, diagram, map, etc.), or other configurations. However, as time passes it may be difficult for a user to recall, for example, the source of particular webpage content that was of interest to the user. As a result, users may struggle to revisit such content once the content is no longer being rendered on the electronic device. Further, although applications exist that enable the user to save portions of articles or other webpage content, such applications are not universally supported among all application providers or in all countries

Example devices of the present disclosure may enable the user to capture a screenshot or other image of the webpage content of interest via, for example, an image capture or screenshot application operable on the device. In some examples, such image capture or screenshot applications are included as standard applications or operating systems on electronic devices configured to render webpage content. As a result, example methods or devices of the present disclosure may enable the user to store and/or share webpage content regardless of the source or format of the webpage content being rendered by the device. In further examples, devices of the present disclosure may enable a use to capture a photograph of a physical content item such as, for example, a magazine article, a journal article, a book, and the like. In such examples, the physical content item may be indexed and/or otherwise searchable via a search engine, and may thus be recoverable by example methods described herein.

In some examples, the user may save the image locally on the device and/or on a cloud-based or otherwise remote service provider. The device or the service provider may recognize text included in the captured image and may form one or more text groups using the recognized text. While various examples of text recognition are described herein, the present disclosure should not be interpreted as being limited to the use of recognized text. For instance, in some examples numbers, symbols, characters, images, and the like may be recognized in the captured image instead of or in addition to text. Thus, in such examples, recognized text may include any type of content recognized in the captured image, and the recognized text may include numbers and/or other characters. In some examples, the recognized text in various text groups may be used to generate one or more searches, such as internet searches, directed towards finding the source webpage on which the originally rendered webpage content resides. In such examples, the one or more text groups formed utilizing the recognized text may be tailored to increase the accuracy of the results yielded by the searches described herein.

The electronic device and/or the service provider may also identify at least one search result indicative of a webpage that includes the originally rendered webpage content. For example, such a search result may be identified by virtue of being included in a predetermined number (e.g., a majority) of the results of the various searches. Additionally, in some examples, such a search result may be identified by virtue of having a relatively high score or other metric indicative of a correlation between the search query used in the respective internet search and content included on the webpage corresponding to the identified search result. Additionally or alternatively, in some examples a search result may be identified by virtue of a determined similarity between a title, URL, snippet, or other content identified in the screenshot and a corresponding title, URL, snippet, or other content of the search result returned by the one or more searches.

In some examples, the electronic device and/or the service provider may generate a content item using content from the webpage corresponding to the identified search result. In some examples, the content item may comprise a version of the website in modified form. For example, such a content item may be optimized for rendering on the display of the electronic device. The content item may be rendered on the device in response to a request received from the user.

The techniques and systems described herein may be implemented in a number of ways. Example implementations are provided below with reference to the following figures.

### Example Architecture

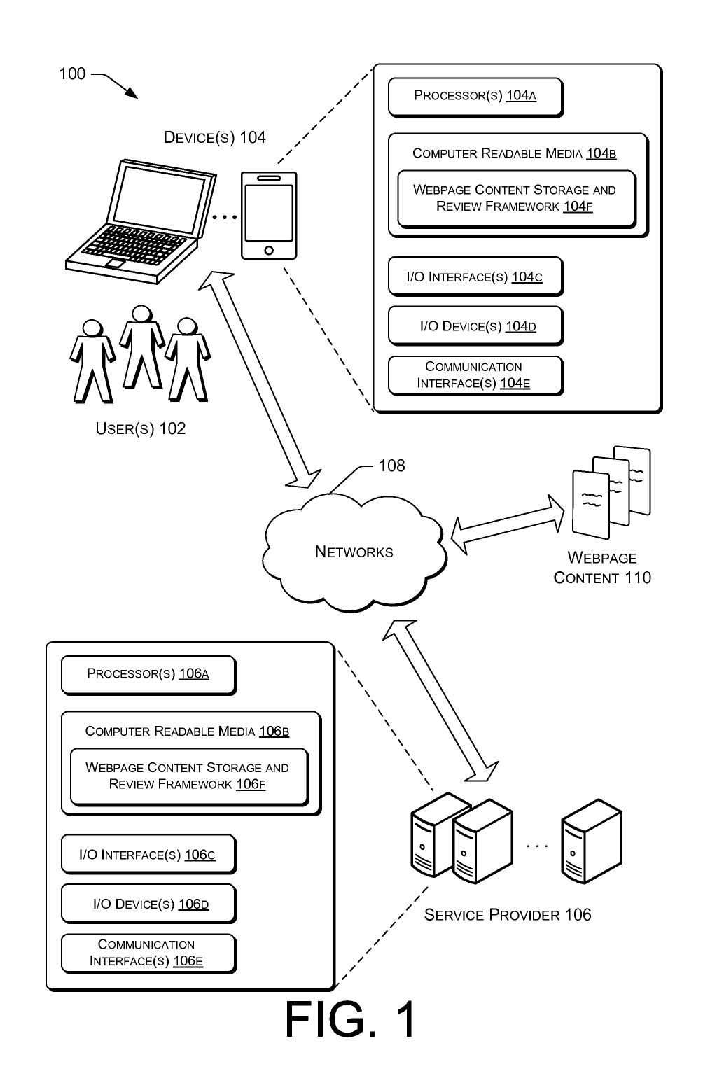

FIG. 1 illustrates an example architecture 100 in which one or more users 102 interact with an electronic device 104, such as a computing device that is configured to receive information from one or more input devices associated with the electronic device 104. For example, the electronic device 104 may be configured to accept information or other such inputs from one or more touch-sensitive keyboards, touchpads, touchscreens, physical keys or buttons, mice, styluses, or other input devices. In some examples, the electronic device 104 may be configured to perform an action in response to such input, such as outputting a desired letter, number, or symbol associated with a corresponding key of the touch-sensitive input device, selecting an interface element, moving a mouse pointer or cursor, scrolling on a page, accessing and/or scrolling content on a webpage, and so on. In some examples, the electronic devices 104 of the present disclosure may be configured to receive touch inputs via any of the touchpads, touchscreens, and/or other touch-sensitive input devices described herein. Additionally, the electronic devices 104 of the present disclosure may be configured to receive non-touch inputs via any of the physical keys, buttons, mice, cameras, microphones, or other non-touch-sensitive input devices described herein. Accordingly, while some input described herein may comprise “touch” input, other input described herein may comprise “non-touch” input.

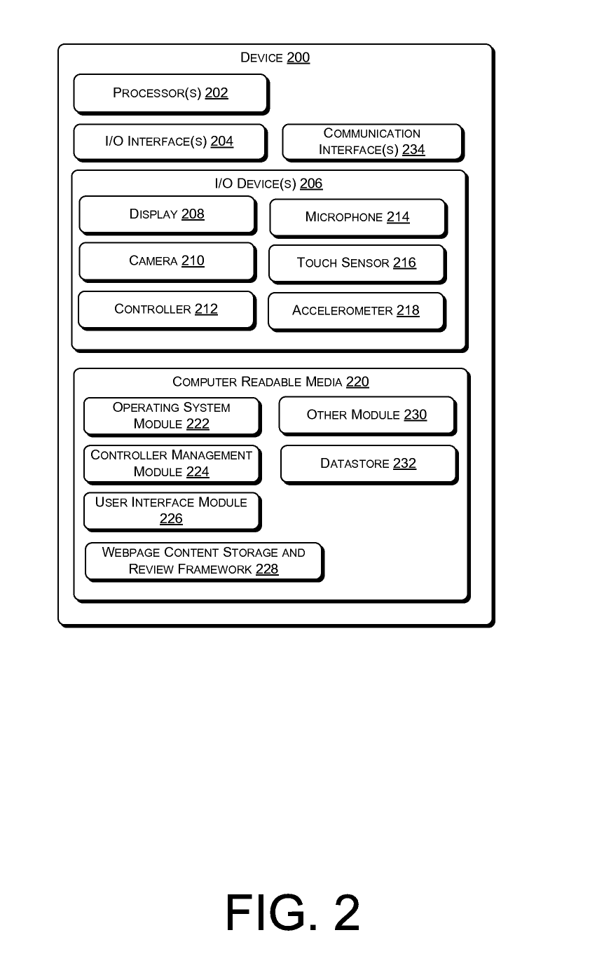

The electronic device 104 may represent any machine or other device configured to execute and/or otherwise carry out a set of instructions. In some examples, such an electronic device 104 may comprise a stationary computing device or a mobile computing device. For example, a stationary computing device 104 may comprise, among other things, a desktop computer, a game console, a server, a plurality of linked servers, and the like. A mobile computing device 104 may comprise, among other things, a laptop computer, a smart phone, an electronic reader device, a mobile handset, a personal digital assistant (PDA), a portable navigation device, a portable gaming device, a tablet computer, a portable media player, a smart watch and/or other wearable computing device, and so on. The electronic device 104 may be equipped with one or more processors 104a, computer readable media (CRM) 104b, input/output interfaces 104c, input/output devices 104d, communication interfaces 104e, displays, sensors, and/or other components. Additionally, the CRM 104b of the electronic device 104 may include, among other things, a webpage content storage and review framework 104f Some of these example components are shown schematically in FIG. 2, and example components of the electronic device 104 will be described in greater detail below with respect to FIG. 2.

As shown in FIG. 1, the electronic device 104 may communicate with one or more devices, servers, service providers 106, or other components via one or more networks 108. The one or more networks 108 may include any one or combination of multiple different types of networks, such as cellular networks, wireless networks, Local Area Networks (LANs), Wide Area Networks (WANs), Personal Area Networks (PANs), and the Internet. Additionally, the service provider 106 may provide one or more services to the electronic device 104. The service provider 106 may include one or more computing devices, such as one or more desktop computers, laptop computers, servers, and the like. In some examples, such service provider devices may include a keyboard or other input device, and such input devices may be similar to those described herein with respect to the electronic device 104. The one or more computing devices of the service provider 106 may be configured in a cluster, data center, cloud computing environment, or a combination thereof. In one example, the one or more computing devices of the service provider 106 may provide cloud computing resources, including computational resources, storage resources, and the like, that operate remotely to the electronic device 104. As shown schematically in FIG. 1, example computing devices of the service provider 106 may include, among other things, one or more processors 106a, CRM 106b, input/output interfaces 106c, input/output devices 106d, communication interfaces 106e, and/or other components. As shown in FIG. 1, the CRM 106b of the computing devices of the service provider 106 may include, among other things, a webpage content storage and review framework 106f. In some examples, the one or more computing devices of the service provider 106 may include one or more of the components described with respect to the electronic device 104. Accordingly, any description herein of components of the electronic device 104, such as descriptions regarding the example components shown in FIGS. 1 and 2, may be equally applicable to the service provider 106.

In some examples, the electronic device 104 and/or the service provider 106 may access digital content via the network 108. For example, the electronic device 104 may access various websites via the network 108, and may, thus, access associated webpage content 110 shown on the website. Such webpage content 110 may be, for example, content that is available on respective webpages of the website. Such webpage content 110 may include, among other things, text, graphics, figures, numbers (such as serial numbers), characters, titles, snippets, URLs, charts, streaming audio or video, hyperlinks, executable files, media files, or other content capable of being accessed via, for example, the internet or other networks 108. In some examples, the webpage content 110 may comprise eBooks, magazine articles, newspaper articles, journal articles, white papers, social media posts, blog posts, PDFs, slideshows, manuals, health metrics (e.g., medical records personal to the user, or other such information accessible in accordance with relevant privacy laws), or other forms of electronic documents or other content published online. Such webpage content 110 may be accessed by the electronic device 104 via one or more internet browsers, search engines, applications, and/or other hardware or software associated with the electronic device 104. Additionally, such webpage content 110 may be accessed by the service provider 106 via one or more internet browsers, search engines, applications, and/or other hardware or software associated with the electronic device 104. For example, such webpage content 110 may be accessed using one or more news applications, blog applications, social media applications, email applications, search engines, and/or applications configured to provide access to a mixture of news, blogs, social media, search engines, and the like. In some examples, the webpage content 110 may include publicly available content that is freely accessible via the internet or other networks. In additional examples, the webpage content 110 may include privately available content that is accessible only to particular individual users 102 (e.g., users 102 that are employees of an organization, members of a club, etc.). In further examples, the webpage content 110 may include content that is accessible by subscription only (e.g., magazine subscription, newspaper subscription, search service subscription, etc.). In examples in which the webpage content 110 includes privately available content or content that is accessible by subscription only, the service provider 106 may also have access to such webpage content 110, such as via a subscription, license, seat, membership, etc. that is shared between the user 102 and the service provider 106.

### Example Device

FIG. 2 illustrates a schematic diagram showing example components included in the electronic device 104 and/or in the computing devices of the service provider 106 of FIG. 1. As shown in FIG. 2, in some examples an electronic device 200 may include one or more processors 202 configured to execute stored instructions. The electronic device 200 may also include one or more input/output (I/O) interfaces 204 in communication with, operably connected to, and/or otherwise coupled to the one or more processors 202, such as by one or more buses.

In some examples, the one or more processors 202 may include one or more processing units. For instance, the processors 202 may comprise at least one of a hardware processing unit or a software processing unit. Thus, in some examples the processors 202 may comprise at least one of a hardware processor or a software processor, and may include one or more cores and/or other hardware or software components. For example, the one or more processors 202 may include a central processing unit (CPU), a graphics processing unit (GPU), a microprocessor, and so on. Alternatively, or in addition, the processor 202 may include one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The processor 202 may be in communication with, operably connected to, and/or otherwise coupled to memory and/or other components of the electronic device 200 described herein. In some examples, the processor 202 may also include on-board memory configured to store information associated with various operations and/or functionality of the processor 202.

The I/O interfaces 204 may be configured to enable the electronic device 200 to communicate with other devices, and/or with the service provider 106 (FIG. 1). In some examples, the I/O interfaces 204 may comprise an inter-integrated circuit (“12C”), a serial peripheral interface bus (“SPI”), a universal serial bus (“USB”), a RS-232, a media device interface, and so forth.

The I/O interfaces 204 may be in communication with, operably connected to, and/or otherwise coupled to one or more I/O devices 206 of the electronic device 200. The I/O devices 206 may include one or more displays 208, cameras 210, controllers 212, microphones 214, touch sensors 216, orientation sensors 218, motion sensors, proximity sensors, pressure sensors, and/or other sensors (not shown). The one or more displays 208 are configured to provide visual output to the user 102. For example, the displays 208 may be connected to the processors 202 and may be configured to render and/or otherwise display content thereon, including the webpage content described herein. In some examples, the display 208 may comprise a touch screen display configured to receive touch input from the user 102. In further examples, the display 208 may comprise a non-touch screen display.

The display 208, camera 210, microphone 214, touch sensor 216, and/or the orientation sensor 218 may be coupled to the controller 212. In some examples, the controller 212 may include one or more hardware and/or software components described above with respect to the processor 202, and in such examples, the controller 212 may comprise a microprocessor, or other device. In further examples, the controller 212 may comprise a component of the processor 202. The controller 212 may be configured to control and receive input from the display 208, camera 210, microphone 214, touch sensor 216, and/or the orientation sensor 218. In some examples, the controller 212 may determine the presence of an applied force, a magnitude of the applied force, and so forth. In some implementations the controller 212 may be in communication with, operably connected to, and/or otherwise coupled to the processor 202. In such examples, one or more of the display 208, camera 210, microphone 214, touch sensor 216, and/or the orientation sensor 218 may be coupled to the processor 202 via the controller 212.

The electronic device 200 may also include or be associated with one or more additional I/O devices not explicitly shown in FIG. 2. Such additional I/O devices may include, among other things, a mouse, physical buttons, keys, a non-integrated keyboard, a joystick, a microphone, a speaker, a printer, and/or other elements associated with an electronic device 200 of the present disclosure. Such I/O devices may be configured to receive a non-touch input from the user 102. Some or all of the components of the electronic device 200, whether illustrated or not illustrated, may be in communication with each other and/or otherwise connected via one or more buses or other means. For example, one or more of the components of the electronic device 200 may be physically separate from, but in communication with, the electronic device 200.

As shown in FIG. 2, the electronic device 200 may also include CRM 220. The CRM 220 may provide storage of computer readable instructions, data structures, program modules and other data for the operation of the electronic device 200. For example, the CRM 220 may store instructions that, when executed by the processor 202 and/or by one or more processors of, for example the service provider 106, cause the one or more processors to perform various acts. The CRM 220 may be in communication with, operably connected to, and/or otherwise coupled to the processors 202 and/or the controller 212, and may store content for display on the display 208.

In some examples, the CRM 220 may include one or a combination of memory or CRM operably connected to the processor 202. Such memory or CRM may include computer storage media and/or communication media. Computer storage media includes volatile and non-volatile, removable and non-removable media implemented in any method or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media does not include communication media.

The CRM 220 may include software functionality configured as one or more “modules.” The term “module” is intended to represent example divisions of the software for purposes of discussion, and is not intended to represent any type of requirement or required method, manner or organization. Accordingly, various such modules, their functionality and/or similar functionality could be arranged differently (e.g., combined into a fewer number of modules, broken into a larger number of modules, etc.). Further, while certain functions and modules may be implemented by software and/or firmware executable by the processor 202, in other examples, one or more such modules may be implemented in whole or in part by other hardware components of the electronic device 200 (e.g., as an ASIC, a specialized processing unit, etc.) to execute the described functions. In some instances, the functions and/or modules are implemented as part of an operating system. In other instances, the functions and/or modules are implemented as part of a device driver (e.g., a driver for a touch surface), firmware, and so on.

In some examples, the CRM 220 may include at least one operating system (OS) module 222. The OS module 222 may be configured to manage hardware resources such as the I/O interfaces 204 and provide various services to applications or modules executing on the processors 202. Also stored in the CRM 220 may be a controller management module 224, a user interface module 226, a webpage content storage and review framework 228, and other modules 230. The controller management module 224 may be configured to provide for control and adjustment of the controller 212. For example, the controller management module 224 may be used to set user-defined preferences in the controller 212.

The user interface module 226 may be configured to provide a user interface to the user 102. This user interface may be visual, audible, or a combination thereof. For example, the user interface module 226 may be configured to present an image or other content on the display 208 and process various touch inputs applied at different locations on the display 208. The user interface module 226 may also be configured to cause the processor 202 and/or the controller 212 to take particular actions, such as paging forward or backward in an e-book or rendered webpage content 110. The user interface module 226 may be configured to respond to one or more signals from the controller 212. These signals may be indicative of the magnitude of a force associated with a touch input, the duration of a touch input, or both. Such signals may also be indicative of any of the non-touch inputs described herein, such as inputs received via one or more physical buttons, keys, mice, or other I/O devices 206.

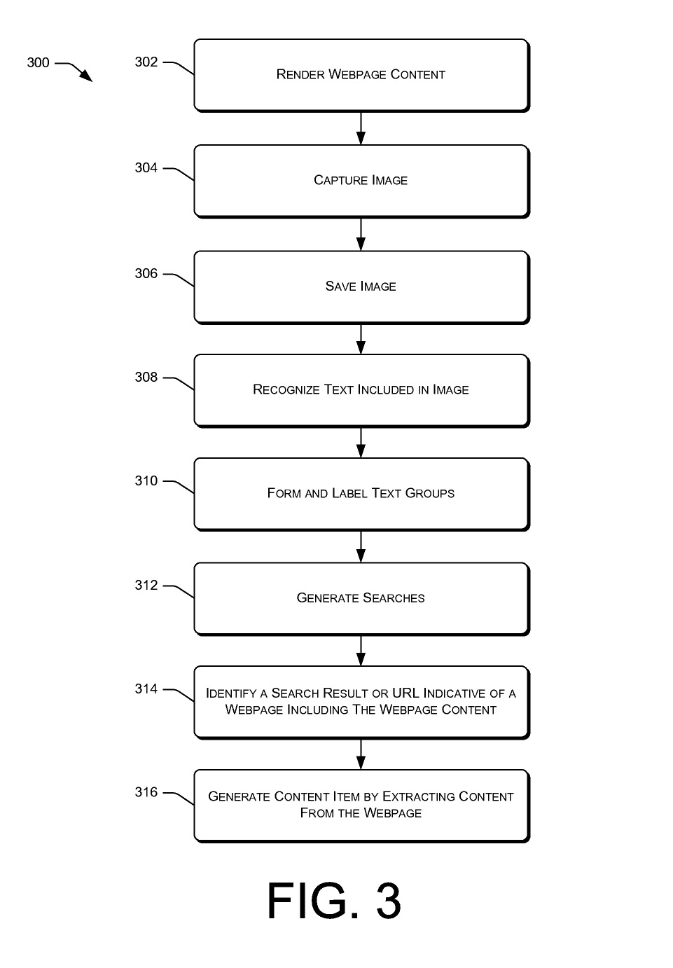

The webpage content storage and review framework 228 (also referred to herein as “framework 228”) may comprise one or more additional modules of the CRM 220. The framework 228 may include instructions that, when executable by the processor 202, cause the processor 202 to perform one or more operations associated with saving images of webpage content and recalling websites including text that is contained in the saved images. For example, the framework 228 may comprise a module configured to cause the processor 202 to capture an image (e.g., a screenshot of webpage content rendered on the display 208, to save the captured image, to recognize text included in the image, and to form one or more text groups using the recognized text. The framework 228 may also cause the processor 202 to generate one or more searches, such as internet searches, using the recognized text of the text groups as search queries. Additionally, the framework 228 may cause the processor to identify at least one search result as being indicative of a webpage that includes the desired webpage content and to generate a content item by extracting content from the webpage. Such operations will be described in greater detail below with respect to, for example, FIGS. 3-9. Additionally, other modules 230 may be stored in the CRM 220. For example, a rendering module may be configured to process e-book files or other webpage content 110 for rendering on the display 208.

The CRM 220 may also include a datastore 232 to store information. The datastore 232 may use a flat file, database, linked list, tree, or other data structure to store the information. In some implementations, the datastore 232 or a portion of the datastore 232 may be distributed across one or more other devices including servers, network attached storage devices, and so forth. The data store 230 may store information about one or more user preferences and so forth. Other data may be stored in the datastore 232 such as e-books, video content, audio content, graphical and/or image content, and/or other webpage content 110. The datastore 232 may also store images, screenshots, or other content captured by one or more hardware components, software components, applications, or other components of the device 204.

The electronic device 200 may also include one or more communication interfaces 234 configured to provide communications between the electronic device 200 and other devices, such as between the electronic device 200 and the service provider 106 via the network 108. Such communication interfaces 234 may be used to connect to one or more personal area networks (“PAN”), local area networks (“LAN”), wide area networks (“WAN”), and so forth. For example, the communications interfaces 234 may include radio modules for a WiFi LAN and a Bluetooth PAN. The electronic device 200 may also include one or more busses or other internal communications hardware or software that allow for the transfer of data between the various modules and components of the electronic device 200.

While FIG. 2 illustrates various example components, the electronic device 200 may have additional features or functionality. For example, the electronic device 200 may also include additional data storage devices (removable and/or non-removable) such as, for example, magnetic disks, optical disks, or tape. The additional data storage media may include volatile and nonvolatile, removable and non-removable media implemented in any method or technology for storage of information, such as computer readable instructions, data structures, program modules, or other data. In addition, some or all of the functionality described as residing within the electronic device 200 may reside remotely from the electronic device 200 in some implementations. In these implementations, the electronic device 200 may utilize the communication interfaces 234 to communicate with and utilize this functionality.

### Example Process

FIG. 3 illustrates a process 300 as a collection of blocks in a logical flow diagram. The process 300 represents a sequence of operations that can be implemented in hardware, software, or a combination thereof. In the context of software, the blocks shown in FIG. 3 represent computer-executable instructions that, when executed by one or more processors, such as the processor 202 and/or a processor of the service provider 106, cause the processor(s) to perform the recited operations. Generally, computer-executable instructions include routines, programs, objects, components, and/or data structures that perform particular functions or implement particular abstract data types. The order in which the operations are described is not intended to be construed as a limitation, and any number of the described blocks can be combined in any order and/or in parallel to implement the processes. For discussion purposes, the process 300 is described with reference to the architecture 100 of FIG. 1 and the components described with respect to FIG. 2. Additionally, each of the operations illustrated in FIG. 3 will be described in greater detail below with respect to FIGS. 3-9. In some examples, each of the operations illustrated in FIG. 3 may be performed by the electronic device 104 and/or components thereof. Additionally, in some examples one or more of the operations illustrated in FIG. 3 may be performed by the service provider 106. For the duration of the disclosure, the electronic device 104 and the service provider 106 may, in some instances, be referred to collectively as the “device 200.” Additionally, the framework 228 may store instructions and/or may otherwise cause the device 200 to perform one or more of the operations described with respect to FIGS. 3-9.

In some examples, the user 102 may initiate one or more of the methods described herein by activating one or more applications on the electronic device 104. Such an application may, for example, enable the user to access and/or view webpage content via the display 208. Such applications may comprise one or more search engines, browsers, content viewers, news applications, blog applications, social media applications, and/or other applications operable on the electronic device 104. Such applications may be activated by, for example, directing one or more touch inputs to the electronic device 104 via the display 208. In other examples, such applications may be activated by directing one or more non-touch inputs to the electronic device 104, such as via one or more physical buttons or keys of the electronic device 104, a mouse connected to the electronic device 104, or other I/O devices 206. As shown in FIG. 3, an example method of the present disclosure includes rendering various webpage content on the display 208 of the electronic device 104 at 302, capturing an image at 304, saving the image at 306, recognizing text included in the image at 308, and forming one or more text groups at 310. In some examples, forming one or more text groups at 310 may also include associating labels with the text groups. An example method of the present disclosure may also include one or more of generating searches using the recognized text at 312, and identifying at least one search result indicative of a webpage including the webpage content at 314. In some examples, each of the search results may be rejected if a score or other metric associated with the search results is determined to be below a corresponding threshold. In such examples, none of the search results may be output or otherwise identified at 314. Example methods of the present disclosure may also include generating a content item by extracting content from the webpage at 316. Each of the above example steps will be described in greater detail with respect to FIGS. 3-9.

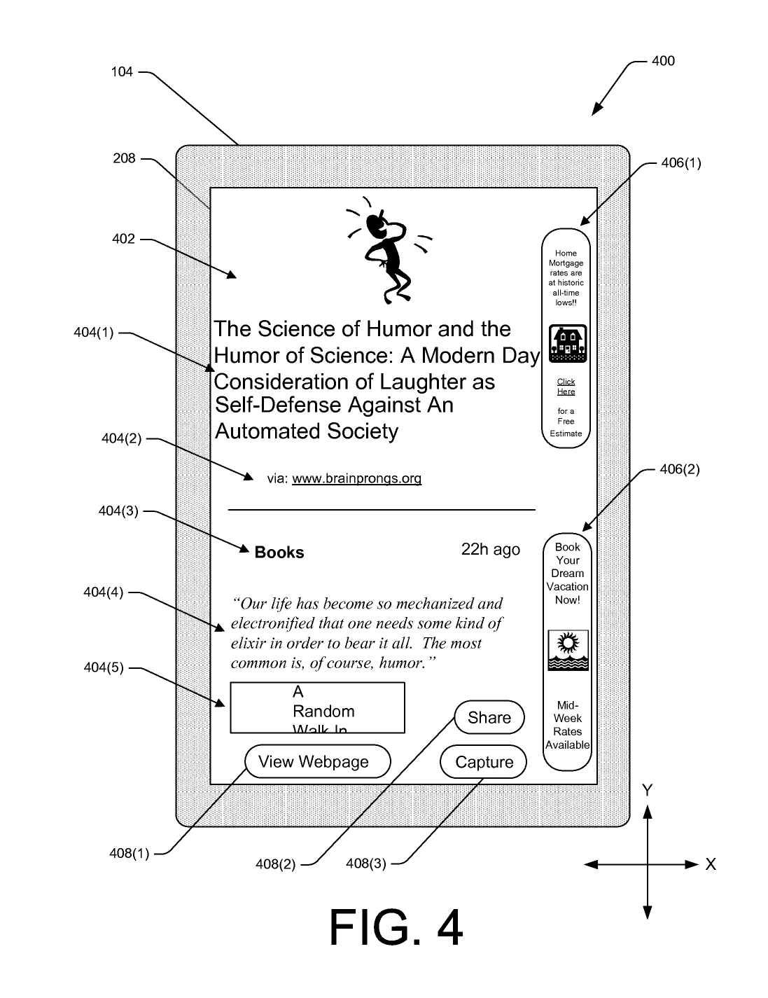

FIG. 4 illustrates an example 400 in which webpage content 402 has been rendered on the display 208, such as at 302. In the illustrated example, the webpage content 402 includes a plurality of text, images, user interface (UI) controls, and the like. For example, webpage content 402 may include primary content 404(1), 404(2), 404(3), 404(4), 404(5)(collectively “primary content 404”), secondary content 406(1), 406(2) (collectively “secondary content 406”), and UI controls 408(1), 408(2), 408(3) (collectively “UI controls 408”). In some examples, the webpage content 402 may have any of a variety of different configurations based on the nature of the webpage being accessed by the electronic device 104. For example, the webpage content 402 may include text having at least one of a plurality of different font sizes, font types, margins, line spacings, paragraph spacings, colors, and/or other text characteristics. As an example, the primary content 404(1) may comprise text having a first font size, a first font type, a first left-hand justified margin, and a first line spacing. The primary content 404(4), on the other hand, may have a second font size less than the first font size, a second font type different from the first font type, a second left-hand justified margin different from the first left-hand justified margin, and a second line spacing approximately equal to the first line spacing. In further examples, however, one or more of the above text characteristics may be different for additional primary content 404 rendered on the display 208. In the various examples described herein, such primary content 404 may comprise the content of the webpage being accessed that the user 102 desires to consume. In some examples, such primary content 404 may comprise one or more sections of the article, journal entry, blog, social media post, white paper, or other webpage content 402 accessed by the user 102.

The secondary content 406 described herein, the other hand, may comprise banner advertisements, background images, pop-up advertisements, headers, footers, sidebars, toolbars, UI controls, and/or other content that is rendered along with the primary content 402, but that is ancillary to, and in some cases unrelated to, the primary content 404. For example, the secondary content 406 illustrated in FIG. 4 includes various advertisements or other content that is rendered simultaneously with the primary content 404. While, in some instances, the secondary content 406 may be targeted to particular users 102 based on, for example, a search history of the user 102, such secondary content 406 may be only tangentially related to the subject matter of the primary content 404. In some examples, a link may take the user 102 to a webpage including the primary and secondary content 404, 406 and the primary content 404 may be directly related to the content of the link (picture or text) that the user 102 clicked on to arrive at the webpage. In some examples, the webpage content rendered at 302 may also include content that comprises locally saved content relevant to the primary content 404. For example, such content may include a snapshot of an application icon on a wireless phone, a tablet, a computer, or other device.

The UI controls 408 may comprise, for example, one or more buttons, icons, or other UI configured to provide functionality to the user 102 associated with the primary content 404 rendered on the display 208. For example, such UI controls 408(1) may enable a user 102 to view, scroll, pan, and/or otherwise interact with a webpage corresponding to and/or that is the source of the webpage content 402 currently being rendered by the display 208. In such examples, the webpage content 402 may be accessed by the electronic device 104 via one or more applications that enable the user 102 to view other webpages therethrough. Alternatively, in other applications, webpage content may reside on a remote and/or cloud-based database. Example applications may include FLIPBOARD™, ZITE™, TUMBLR™, FACEBOOK™, TWITTER™, FACEBOOK PAPER™, KLOUT™, and/or other applications or websites. Such UI controls 408(2) may also enable the user 102 to share, via one or more social media applications, instant messaging applications, email applications, message board applications, and/or other applications, at least a portion of the webpage content 402 being rendered on the display 208. Still further UI controls 408(3) may enable the user 102 to capture an image of at least a portion of the webpage content 402. In some examples, such an image may comprise, among other things, a screenshot of at least a portion of the webpage content 402. In some examples, such UI controls 408(3) may activate and/or utilize one or more copy and/or save functions of the electronic device 104. Activation of such UI controls 408(3) may copy an image of at least a portion of the primary content 404 and/or the secondary content world 406 being rendered on the display 208, and may save the copied image in, for example, the CRM 220 of the electronic device 104. Additionally, the copied image may be emailed and/or otherwise provided to the service provider 106, via the network 108, in response to activation of the UI control 408(3), and the copied image may be saved in a memory of the service provider 106.

For example, as shown in operation 304 of FIG. 3, in an example method of the present disclosure the processor 202 and/or applications or modules operable via the processor 202, such as the framework 228, may capture an image of at least a portion of the webpage content 402 being rendered on the display 208. In some examples, such an image may include a screenshot of the webpage content 402 that is captured by the processor 202 and/or applications or modules operable via the processor 202 while display 208 is rendering the webpage content 402. As shown in FIG. 4, in some examples the captured image may include, among other things, one or more figures and at least some text.

At 306, the processor 202 and/or applications or modules operable via the processor 202, such as the framework 228, may save the captured image (i.e., the screenshot) in the CRM 220 of the electronic device 104. Additionally, at 306 the processor 202 and/or applications or modules operable via the processor 202 cause the captured image to be sent to the service provider 106, via the network 108. In such examples, the service provider may save the captured image in a memory of the service provider 106 upon receipt, and such memory may be remote from the electronic device 104. In some examples, both the CRM 220 and the memory of the service provider 106 may be in communication with, coupled to, operably connected to, and/or otherwise associated with the electronic device 104.

In some examples, at least one of capturing the image at 304 or saving the image at 306 may cause, for example, the processor 202 and/or other hardware or software components of the electronic device 104 to send the captured image to the service provider 106. For example, a software application executed by the processor 202 may generate an email, including the captured image as an attachment thereto, in response to the captured image being detected in a designated folder, such as a “photos” folder or an “images” folder, of the CRM 220. In such examples, the software application may cause the processor 202 to send the email from the electronic device 104 to the service provider 106. In still further examples, any other methods or protocols may be utilized instead of and/or in combination with email in order to transfer the captured image from the electronic device 104 to the service provider 106, and such example protocols may include, among other things, file transfer protocol (FTP).

At 308, the processor 202 and/or other hardware or software components of either the electronic device 104 or the service provider 106, such as the framework 228, may recognize, using optical character recognition (OCR), text that is included in the captured image. For example, such OCR may be performed by various programs, application, and/or other software saved in either the CRM 220 and/or in a memory of the service provider 106. In some examples, and OCR process performed by such software may convert portions of the captured image into machine-encoded/computer-readable text. In this way, at least a portion of the captured image may be electronically edited, searched, stored, displayed, and/or otherwise utilized by components of the device 14 and/or the service provider 106 for one or more of the operations described with respect to FIG. 3. For example, as will be described in greater detail below, text of the captured image that is recognized by the OCR process performed at 308 may be utilized to perform various Internet-based searches for webpages that include the webpage content 402. Further, in some examples recognizing such text at 308 may include recognizing text that is included in a captured screenshot at least partially in response to saving the image (i.e., the screenshot) in either the CRM 220 of the electronic device 104 or in a memory of the service provider 106.

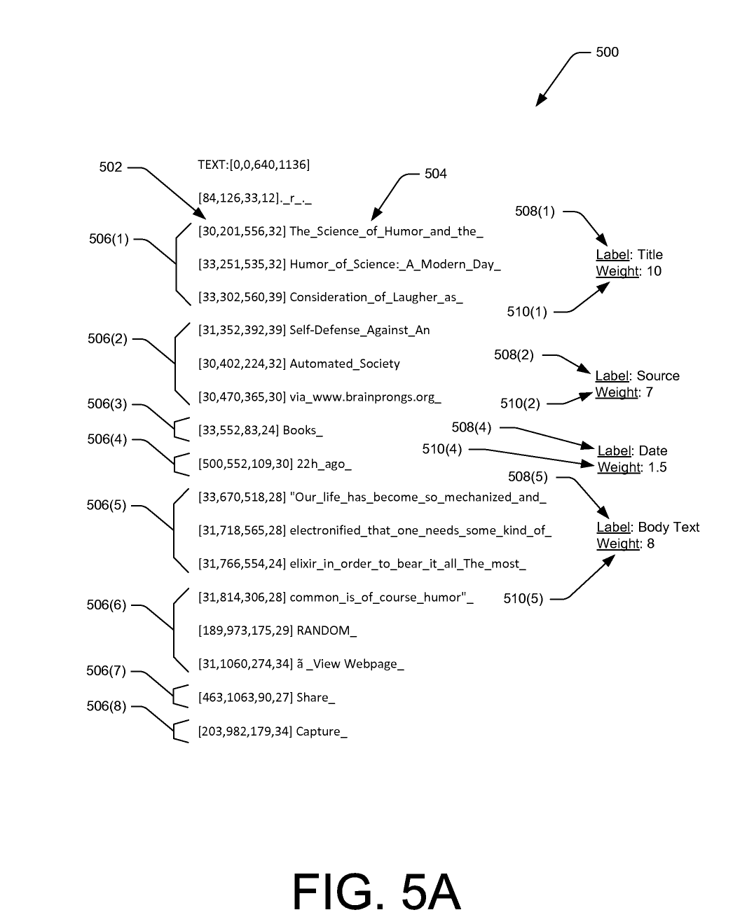

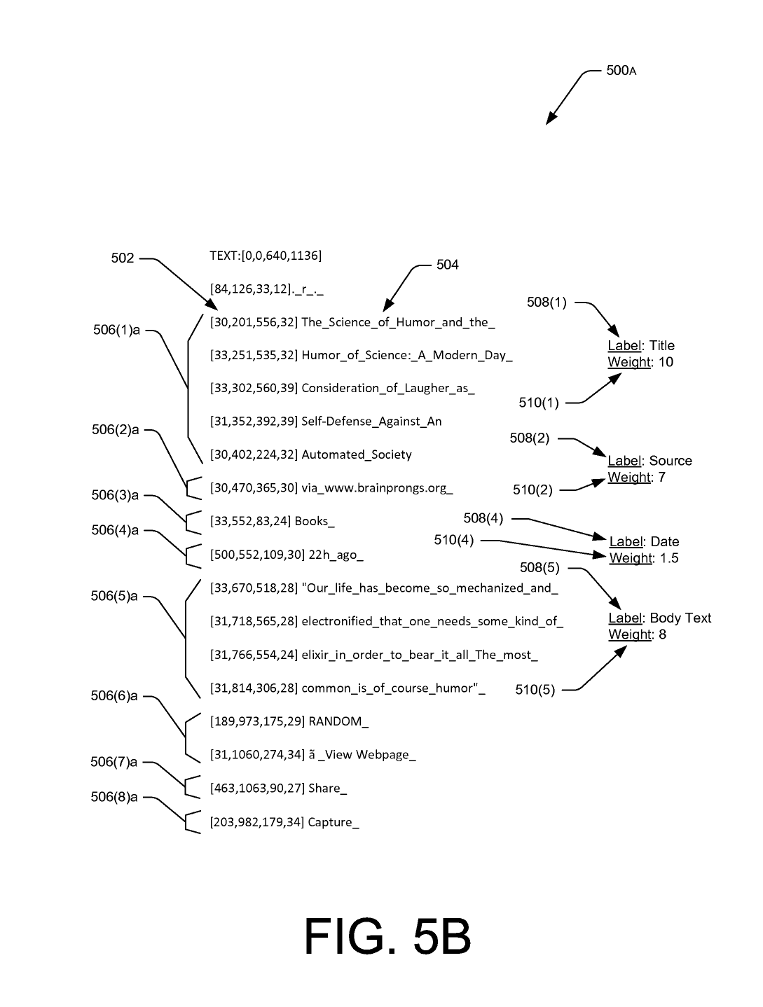

FIG. 5A illustrates an example result 500 of the OCR process performed at 308. For example, in some examples the processor 202 and/or other hardware or software components of either the electronic device 104 or the service provider 106 may output a plurality of OCR lines at 308, and each OCR line may include, among other things, an array 502 in combination with recognized text 504. In some examples, the array 502 may identify, in the form of respective numbers of pixels, X-Y coordinates, and/or other quantifiable metrics, various characteristics of the recognized text 504 corresponding to the array 502. For example, each array 502 may include respective values indicative of a location on the display 208 at which the top of the text corresponding to the recognized text 504 (i.e., the webpage content 402) has been rendered. Each array 502 may also include respective values indicative of a location on the display 208 at which a leftmost portion of the text corresponding to the recognized text 504 (i.e., the webpage content 402) has been rendered. Such “top” and “left” values are illustrated as the first and second numerals of each array 502 shown in FIG. 5A.

In some examples, at least one of the top or left values of the array 502 may be utilized to determine, for example, a position of a corresponding line of text, a relationship between the corresponding line of text and at least one other line of text, and/or other characteristics associated with the webpage content 402 and/or the recognized text 504. Additionally, each array 502 may include respective values indicative of an overall width of the text corresponding to the recognized text 504 (i.e., the webpage content 402), and of an overall height of the text corresponding to the recognized text 504 (i.e., the webpage content 402). Such “width” and “height” values are illustrated as the third and fourth numerals of each array 502 shown in FIG. 5A. In some examples, such width and height values may be indicative of, for example, a font size of the recognized text 504, a font type of the recognized text 504, a number of pixels of the display 208 utilized in rendering the corresponding text of the webpage content 402, or any other dimensional metric. One or more of the top, left, width, or height values described herein may be used, either alone or in combination, to determine line spacing, margins, formatting, or other characteristics of the recognized text 504.

At 310, the processor 202 and/or other hardware or software components of either the electronic device 104 or the service provider 106, such as the framework 228, may form a plurality of text groups based at least in part on the text included in the captured image. For example, such text groups may be formed based at least in part on the text recognized at 308, and a plurality of example text groups 506(1), 506(2), 506(3), 506(4), 506(5), 506(6), 506(7), 506(8) (collectively, “text groups 506”) are illustrated in FIG. 5A. The various text groups 506 of the present disclosure may be formed in any conventional manner in order to assist in recovering, for example, a webpage including the webpage content 402. For example, the recognized text 504 may be grouped based on one or more characteristics of the recognized text 504 and/or of the webpage content 402 corresponding to the recognized text 504. In some examples, such characteristics may include, among other things, the width, line spacing, and/or margins of the corresponding webpage content 402, location on the display 208 at which the webpage content 402 has been rendered, and/or other characteristics. In some examples, the OCR process performed at 308 may include forming at least one of the of the text groups 506 described herein. In further examples, the processor 202 and/or other hardware or software components of either the electronic device 104 or the service provider 106 may also form one or more of the text groups 506 based at least in part on grammar, syntax, heuristics, definition, semantic, and/or other context-based characteristics of the webpage content 402 and/or of the recognized text 504.

For example, forming the plurality of text groups 506 may include grouping adjacent lines of recognized text 504 having respective widths that are approximately equal when the corresponding webpage content 402 is rendered on the display 208. For example, as can be seen in FIG. 4, when the webpage content 402 corresponding to the text group 506(1) is rendered on the display 208, the three lines of text corresponding to the text group 506(1) have an overall width in the direction of the X-axis that is approximately equal. Such an approximately equal width dimension is also illustrated in, for example, the respective third values of the arrays 502 corresponding to the text group 506(1). Further, such approximately equal width dimensions may be different from, for example, the respective width dimensions of the text corresponding to the adjacent text group 506(2) by greater than a threshold amount. Such a difference may further assist the processor 202 and/or other hardware or software components of either the electronic device 104 or the service provider 106 in forming such text groups 506.

In some examples, forming the plurality of text groups 506 may also include grouping adjacent lines of recognized text 504 having approximately equal vertical spacing between the respective text lines when the corresponding webpage content 402 is rendered on the display 208. For example, as can be seen in FIG. 4, when the webpage content 402 corresponding to the text group 506(1) is rendered on the display 208, the three lines of text corresponding to the text group 506(1) have a line spacing in the direction of the Y-axis that is approximately equal. Such an approximately equal line spacing may also be illustrated in, for example, one or more of the respective values of the arrays 502 corresponding to the text group 506(1). Further, such approximately equal line spacing may be different from, for example, the respective line spacing of the text corresponding to the adjacent text group 506(2) and/or other text groups 506 by greater than a threshold amount. Such a difference may further assist the processor 202 and/or other hardware or software components of either the electronic device 104 or the service provider 106 in forming such text groups 506.

In still other examples, forming the plurality of text groups 506 may include grouping adjacent lines of recognized text 504 having respective margins that are approximately equal when the corresponding webpage content 402 is rendered on the display 208. For example, as can be seen in FIG. 4, when the webpage content 402 corresponding to the text group 506(1) is rendered on the display 208, the three lines of text corresponding to the text group 506(1) each have a left-hand margin that is approximately equal. In some examples, such an approximately equal left-hand margin may also be illustrated in, for example, one or more of the respective values of the arrays 502 corresponding to the text group 506(1). Further, such approximately equal margins may be different from, for example, the respective margins of the text corresponding to the adjacent text group 506(2) and/or or to other text groups 506 by greater than a threshold amount. Such a difference may further assist the processor 202 and/or other hardware or software components of either the electronic device 104 or the service provider 106 in forming such text groups 506. In the example OCR results 500 shown in FIG. 5A, a total of eight text groups 506 have been formed based on one or more of the factors described above, and/or other factors associated with the webpage content 402 corresponding to the respective text groups 506.

In additional examples, forming the plurality of text groups 506 may include grouping words or lines of recognized text 504 based on one or more of the respective margins, font sizes, font types, alignments, and/or other characteristics of the recognized text 504 when the corresponding webpage content 402 is rendered on the display 208. For example, when webpage content 402 is rendered on the display 208, two or more adjacent lines of text may have respective font sizes. The processor 202 and/or other hardware or software components of either the electronic device 104 or the service provider 106 may determine the respective font sizes of the adjacent lines at 310. The adjacent lines of text may also have respective “left” values or other values indicative of the location and/or alignment of the respective lines of text. For example, the two or more adjacent lines of text may have a “left” value (as described above with respect to FIG. 5A) if the lines of text are left-aligned when rendered on the display 208. Alternatively, if the lines of text are center-aligned when rendered on the display 208, the lines of text may have respective “center” values indicating the distance from the beginning or end of the line to the center of the webpage or to the center of the respective line of text. Further, if the lines of text are horizontal-aligned, the lines of text may have respective “bottom” values indicating the distance from the respective text line to either the bottom of the webpage or to the top of the webpage. In such examples, the font size and/or one or more of the left, center, bottom, top, or other values described herein may be used to form one or more text groups 506 at 310.

For example, the processor 202 and/or other hardware or software components of either the electronic device 104 or the service provider 106 may group two or more adjacent lines of text if a difference between the respective font sizes of the adjacent lines is below a font size difference threshold and if respective left, center, bottom, top, or other values of adjacent lines of text are substantially equal. In addition to determining a difference between the respective font sizes of the adjacent lines, the processor 202 and/or other hardware or software components of either the electronic device 104 or the service provider 106 may determine a difference between the respective left, center, bottom, top, or other values of the adjacent lines of text. If the determined difference between the respective font sizes is below the font size difference threshold, and if the difference between one or more of the respective left, center, bottom, top, or other values of the adjacent lines of text is below a corresponding threshold, the processor 202 and/or other hardware or software components of either the electronic device 104 or the service provider 106 may form a text group 506 with the adjacent lines of text at 310.

In still further examples, forming the plurality of text groups 506 at 310 may include grouping words or lines of recognized text 504 according to one or more grammar, syntax, definition, semantic, heuristic, and/or other rules (referred to collectively herein as “context-based grouping rules”). As can be seen in the example OCR results 500a shown in FIG. 5B, the lines of text corresponding to the text group 506(1)a may be grouped based on a common contextual relationship. For example, such a common contextual relationship may indicate that such lines of text may, in combination, comprise a particular identifiable portion of the webpage content 402. In the present example, such a portion may comprise the title of the webpage content 402. In other examples, however, such a portion may comprise the body text or other portions.

At 310, the processor 202 and/or other hardware or software components of either the electronic device 104 or the service provider 106 may analyze the recognized text 504 with reference to one or more context-based grouping rules and may, in response, determine that at least a portion of the recognized text 504 shares a common semantic meaning or other such contextual relationship and, thus, may be associated with a common label (e.g., a title, a body text, etc.). Such rules may include, for example, definition, grammar and/or syntax rules associated with the particular language (e.g., English, Spanish, Italian, Russian, Chinese, Japanese, German, Latin, etc.) of the recognized text 504, and some such rules may be language-specific. In response to making such a determination, the processor 202 and/or other hardware or software components of either the electronic device 104 or the service provider 106 may form a single text group (e.g., 506(1)a) with such text even if the formation of such a text group 506(1)a may conflict with other text group formation rules described herein.

For example, although the text group 506(1)a may include a number of words greater than a predetermined threshold used to limit text groups, in some embodiments, such a threshold may be ignored if, for example, the processor 202 and/or other hardware or software components of either the electronic device 104 or the service provider 106 determines that at least a portion of the recognized text 504 shares a common semantic meaning. Such context-based rules may result in the formation of text groups 506 that are more linguistically and/or semantically accurate than some of the text groups 506 described above with respect to, for example, FIG. 5A. For example, the full title 404(1) of the example article shown in FIG. 4 is “The Science of Humor and the Humor of Science: A Modern Day Consideration of Laughter as Self-Defense Against An Automated Society.” As shown in FIG. 5A, according to some examples, this title may be divided between two text groups 506(1), 506(2). If, however, one or more of the context-based rules of the present disclosure are used to form text groups 506 from the recognized text 504 at 310, the processor 202 and/or other hardware or software components of either the electronic device 104 or the service provider 106 may recognize a common contextual relationship shared by the recognized text 504 associated with the above title. As a result, as shown in FIG. 5B, the processor 202 and/or other hardware or software components of either the electronic device 104 or the service provider 106 may form a text group 506(1)a including all of the text of the full title.

In additional examples, such context-based rules may also be used to divide text groups into two or more individual text groups. For example, the text group 506(2) of FIG. 5A may be formed to include three lines (the first two lines being part of the title, and the third line indicating the source of the article) based on the width, margins, and/or other characteristics of corresponding webpage content 402. In other examples, however, the text group 506(2) may be divided based on the context-based rules described herein. As shown in FIG. 5B, in such examples, the first two lines of the text group 506(2) may be added to the text group 506(1)a, and the last line of the text group 506(2) may form a separate text group 506(2)a. In some examples, internet searches performed using text from various text groups formed by employing context-based rules may result in more accurate search results.

In further examples, the processor 202 and/or other hardware or software components of either the electronic device 104 or the service provider 106 may associate at least one of a label 508(1), 508(2) . . . 508(n) (collectively, “labels 508”) or a weight 510(1), 510(2) . . . 510(n) (collectively, “weights 510”) with one or more of the text groups 506. In some examples, the processor 202 and/or other hardware or software components of either the electronic device 104 or the service provider 106 may generate one or more such labels 508 based on, among other things, characteristics of the recognized text 504, context information, grammar, syntax, and/or other semantic information associated with the recognized text 504. For example, the OCR process employed at 308 may include, among other things, a syntax evaluation of the recognized text 504. Such a syntax evaluation may provide information regarding the type of recognized text 504 included in the OCR results 500. In particular, such an evaluation may provide information indicative of whether the recognized text 504 includes one of a title, author, date, body text (e.g., a paragraph), or source of the webpage content 402. Accordingly, the processor 202 and/or other hardware or software components of either the electronic device 104 or the service provider 106 may associate one of a “title,” “author,” “date,” “body text,” or “source” label with at least one of the text groups 506 based on such information. In some examples, the label 508 associated with the respective text groups 506 may be used to determine, for example, whether or not to utilize the recognized text 504 included in the corresponding text group 506 when performing one or more searches, such as internet searches. In further examples, one or more additional labels 508 may also be associated with respective text groups 506. Additionally, the one or more labels 508 may, in some examples, identify a common contextual relationship shared by adjacent lines of text forming the respective text group 506 with which the label 508 is associated.

In some examples, the syntax evaluation described above may employ one or more characterization rules in associating a label 508 with the respective text groups 506. For example, in most webpage content a title of an article may be characterized by being positioned proximate or at the top of the webpage. Additionally the title of an article may typically be rendered with a larger font size than the remainder of the article and/or may be rendered with bold font. Thus the syntax evaluation performed during the OCR process employed at 308 may take such common title characteristics into account when associating a “title” label 508(1) with a respective text group 506(1). Similarly, in the English language the first letter of an author's first, last name, and middle initial may be capitalized, and in most instances, the author's name may be preceded by the word “by.” Additionally, in some instances an author's first name may be relatively common and, thus, may be included in one or more lookup tables stored in memory. As a result, the syntax evaluation performed during the OCR process employed at 308 may take such common author name characteristics into account when associating a “name” or “author” label 508 with a respective text group 506.

In additional examples, a date of publication and/or posting may sometimes be represented in the webpage content 402 in a fixed format. For example, it is customary to list a date using a month, day, year format in the English language. Additionally, in other countries it may be common to utilize a day, month, year format. Further, since the names of the 12 months are known, such months can be easily referenced in one or more lookup tables stored in memory. Accordingly, the syntax evaluation performed during the OCR process employed at 308 may take such common date characteristics into account when associating a “date” label 508(4) with a respective text group 506(4). In still further examples, the source of the webpage content 402 may often be represented using at least one of a “www” or a “http://” identifier. Thus, the syntax evaluation performed during the OCR process employed at 308 may recognize such common source identifiers when associating a “source” label 508(2) with a respective text group 506(2).

Further, the various weights 510 assigned to and/or otherwise associated with the various text groups 506 may have respective values indicative of, for example, the importance of recognized text of the type characterized by the corresponding label 508. For example, when performing an internet search in order to recover the webpage content 402, utilizing some types of text as a search query may result in more accurate search results than utilizing other different types of text as a search query. In particular, when performing an internet search to recover the webpage content 402 illustrated in FIG. 4, utilizing recognized text 504 included in the text group 506(5) that has been labeled as “body text” (i.e., text of the body of an article) as a search query in an internet search engine may yield relatively accurate search results. Accordingly, a relatively high weight 510(5) (e.g., a weight of “8” on an example weight scale of 1-10) may be associated with the text group 506(5) based at least in part on the “body text” label 508(5) associated with the text group 506(5). Likewise, utilizing recognized text 504 included in the text group 506(4) that has been labeled as “date” (i.e., the date of publication of an article) as a search query in an internet search engine may yield relatively inaccurate search results. Accordingly, a relatively low weight 510(4) (e.g., a weight of “1.5” on an example weight scale of 1-10) may be associated with the text group 506(4) based at least in part on the “date” label 508(4) associated with the text group 506(4). Further, the processor 202 and/or other hardware or software components of either the electronic device 104 or the service provider 106 may omit one or more of the text groups 506 when performing various searches based at least in part on the label 508 and/or the weight 510 associated with the respective text group 506. For example, recognized text 504 included in a text group 506 having a respective label 508 that is not included in a list of preferred labels or, that is included in a list of low accuracy labels may not be utilized as a search query when performing various searches. Additionally, recognized text 504 included in a text group 506 having a respective weight 510 that is below a predetermined minimum weight threshold or that is above a predetermined maximum weight threshold may not be utilized as a search query when performing various searches. Omitting such text groups from the searches being performed, based at least in part on the label and/or the weight associated with the omitted text group, may reduce and/or minimize the number of searches required to be performed by the processor 202 and/or other hardware or software components of either the electronic device 104 or the service provider 106 in order to recover desired webpage content. As a result, examples of the present disclosure may improve the search speed and/or performance of the processor 202 and/or other hardware or software components of either the electronic device 104 or the service provider 106. Such examples may also reduce the computational, bandwidth, memory, resource, and/or processing burden placed on the processor 202 and/or other hardware or software components of either the electronic device 104 or the service provider 106.

In still further examples, the processor 202 and/or other hardware or software components of either the electronic device 104 or the service provider 106 may omit one or more of the text groups 506 when performing various searches based at least in part on a variety of additional factors. For example, the processor 202 and/or other hardware or software components of either the electronic device 104 or the service provider 106 may determine that at least one text group 506 of the plurality of text groups 506 has a number of words less than a minimum word threshold. In some examples, searches performed using search queries that include less than a minimum word threshold (e.g., four words) may yield search results that are less accurate than, for example, additional searches that are performed using search queries that include greater than such a minimum word threshold. For example, a first internet search performed using the recognized text 504 of the text group 506(3) (i.e., that includes one word “books”) may yield search results that are relatively inaccurate when compared to, for example, a second internet search performed using the recognized text 504 of the text group 506(1). As a result, the processor 202 and/or other hardware or software components of either the electronic device 104 or the service provider 106 may omit one or more text groups 506 from the plurality of searches to be generated based at least in part on determining that the at least one text group 506 has a number of words less than the predetermined minimum word threshold.

As shown in FIG. 3, at 312 the processor 202 and/or other hardware or software components of either the electronic device 104 or the service provider 106, such as the framework 228, may generate one or more searches or queries, such as internet searches, using the recognized text 504 described above with respect to FIGS. 5A and 5B. In some examples, the processor 202 and/or other hardware or software components of either the electronic device 104 or the service provider 106, such as the framework 228, may generate a plurality of searches, and each search of the plurality of searches may be performed by a different respective search engine or other application associated with the electronic device 104 or the service provider. Further, in some examples, each of the searches may be performed using text from a different respective text group 506 as a search query. For example, the processor 202 and/or other hardware or software components of either the electronic device 104 or the service provider 106 may utilize one or more internet search engines to perform each respective internet search, and in doing so, may utilize one or more lines and/or other portions of the recognized text 504 as a search query for each search. Accordingly, each search may yield a respective search result that includes a plurality of webpage links. In some examples in which a different search query (e.g., different recognized text 504) is utilized in each internet search, such searches may yield different respective search results.

As noted above, the processor 202 and/or other hardware or software components of either the electronic device 104 or the service provider 106 may be selective when choosing the one or more text groups 506 from which recognized text 504 may be utilized as a search query for the searches generated at 312. For example, as noted above, a minimum word threshold may be employed to determine the one or more text groups 506 from which recognized text 504 may be utilized. As noted above, an example minimum word threshold may be approximately four words, and in such examples only text groups 506 including recognized text 504 of greater than or equal to four words may be utilized to generate searches, such as internet searches, at 312. The above minimum word thresholds are merely examples, and in further examples a minimum word threshold greater than or less than four (such as 2, 3, 5, 6, etc.), may be employed.

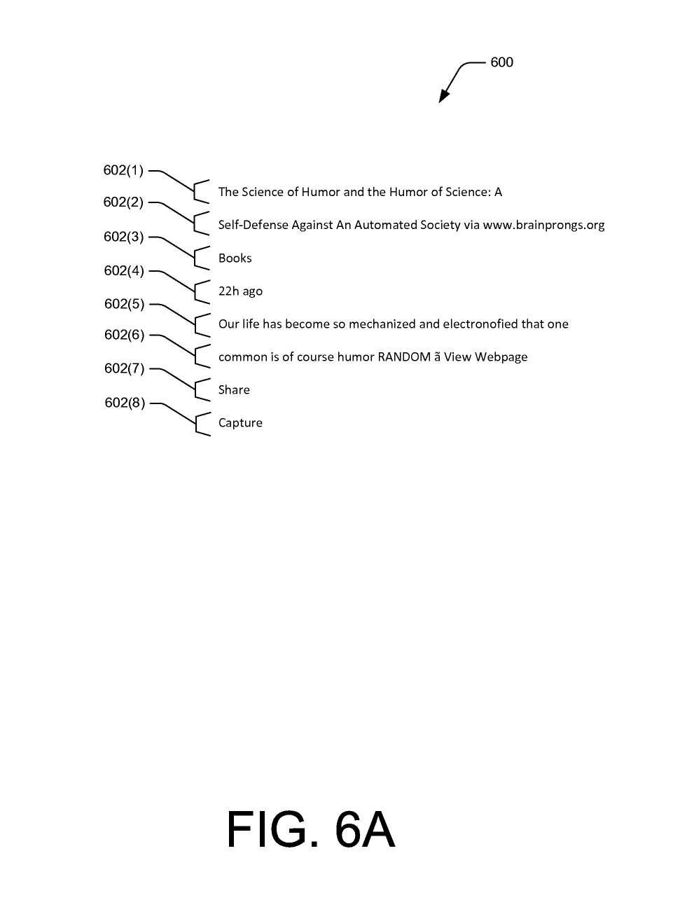

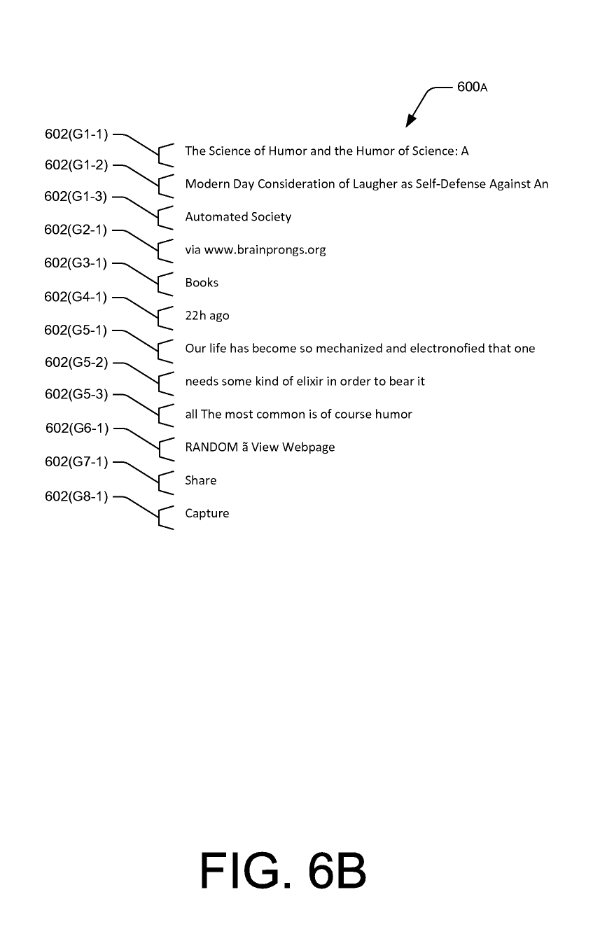

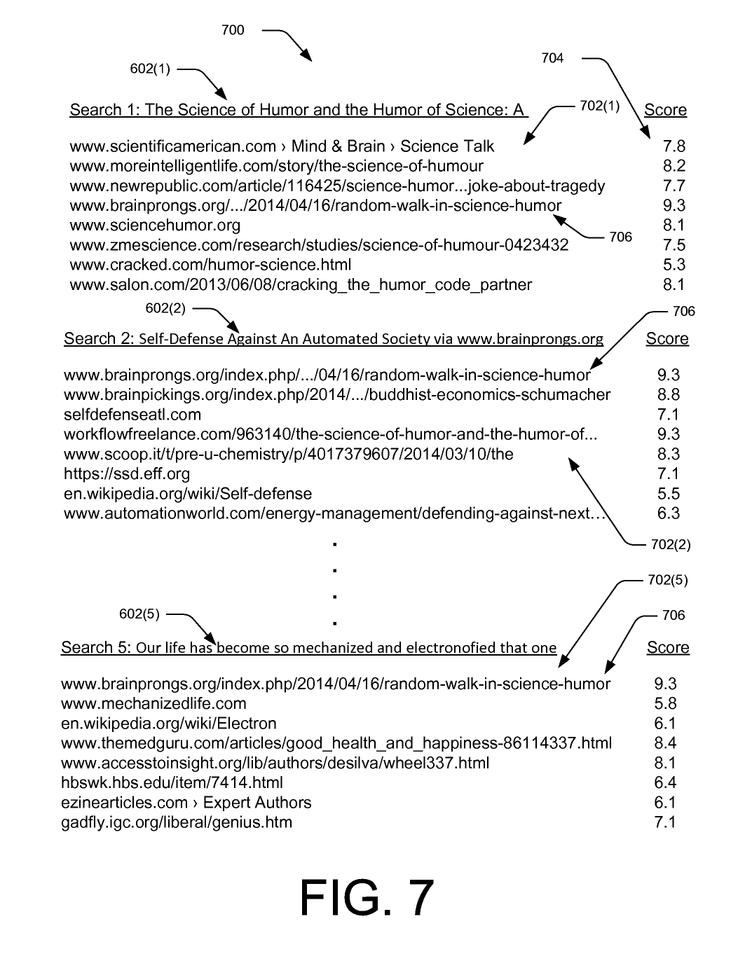

Further, as shown in the example 600 of FIG. 6A, some search queries may be truncated for use in generating the searches at 312. The search queries 602(1), 602(2), 602(3), 602(4), 602(5), 602(6), 602(7), 602(8) (collectively, “search queries 602”) shown in FIG. 6A are indicative of example search queries that may be employed at 312 based on the recognized text 504 shown in FIG. 5A. In some examples, the processor 202 and/or other hardware or software components of either the electronic device 104 or the service provider 106 may employ one or more truncation rules in order to generate one or more of the search queries 602. For example, if a text group 506 includes a number of words greater than a maximum word threshold, all words in the text group 506 after the maximum word threshold may be omitted from the search query 602. In some examples, such a maximum word threshold may be equal to approximately 10 words. FIG. 6A illustrates an example in which such a maximum word threshold has been employed to truncate the recognized text 504 of the various text groups 506 shown in FIG. 5A. For example, the text group 506(1) shown in FIG. 5A includes a total of 16 words. As part of generating the internet search at 312, however, the processor 202 and/or other hardware or software components of either the electronic device 104 or the service provider 106 may truncate the recognized text 504 of the text group 506(1) such that only the first ten words of recognized text (i.e., a number of words less than or equal to the maximum word threshold) are used as a corresponding search query 602(1). Further, the search queries 602(3), 602(4), 602(6), 602(7), and 602(8) correspond to the respective text groups 502(3), 502(4), 502(6), 502(7), and 502(8) shown in FIG. 5A. However, in examples in which a relatively high minimum word threshold has been employed, and in which the processor 202 and/or other hardware or software components of either the electronic device 104 or the service provider 106 determines that such text groups 502 include a number of words less than such a minimum word threshold, the processor 202 and/or other hardware or software components of either the electronic device 104 or the service provider 106 may omit such text groups 502 and/or the corresponding search queries 602 from the plurality of searches generated at 312. In some examples in which the minimum word threshold is equal to approximately ten, the text groups 502(3), 502(4), 502(6), 502(7), and 502(8) shown in FIG. 5A may be omitted from the plurality of searches generated at 312. Example search results 700 generated at 312, using the search queries 602(1), 602(2), and 602(5), are illustrated in FIG. 7.

In some examples, various additional grouping or truncation rules may be used to form the search queries 602 described herein. For instance, in some examples respective search queries 602 may be formed by selecting a desired number of adjacent words in a text group 502. In such examples, a text group 502 may be segmented into a plurality of separate search queries 602, each separate search query including the desired number of adjacent words from the text group 502, and in the event that there is a reminder of words in the text group 502 less than the desired number, the remainder of words may be used as an additional separate search query 602. In such examples, there may be no overlap between search queries 602 formed from a particular text group 502 (e.g., none of the adjacent words in the text group 502 may be included in more than one search query 602). FIG. 6B illustrates a plurality of search queries 602a formed using such additional grouping or truncation rules. As shown in FIG. 6B, in an example of the present disclosure three separate search queries 602(G1-1), 602(G1-2), 602(G1-3) may be formed from the recognized text 504 of the text group 506(1)a shown in FIG. 5B. In forming search queries 602(G1-1) and 602(G1-2), ten adjacent words are used. In forming search query 602(G1-3), the remaining words of text group 506(1)a are used.

Additionally, in some examples one or more modifiers may be used when forming search queries 602 of the present disclosure. For example, quotes (“ ”) may be employed to direct the processor 202 and/or other hardware or software components of either the electronic device 104 or the service provider 106 to affect the search results resulting from the query. Using quotes, for example, may require that the search results contain the exact string of ordered words disposed between the quotes. Additionally, a plus sign (+) may be employed to combine two or more separate search queries. Further, the use of multiple modifiers (e.g., quotes and a plus sign) may be used in one or more internet searches in order to increase the accuracy of search results. For example, a combined search query in which the exact string of ordered words appearing in search queries 602(G1-1) and 602(G2-1) is desired may be as follows: “The Science of Humor and the Humor of Science: A”+“via www.brainprongs.org.”

As shown in FIG. 7, the search results 700 may comprise a respective search result 702(1), 702(2), 702(5) corresponding to each of the search queries 602(1), 602(2), 602(5) utilized at 312. Additionally, each respective search result 702(1), 702(2), 702(5) may include one or more webpage links as is common for most internet search engines. In particular, the webpage links included in each respective search result 702(1), 702(2), 702(5) may be indicative of webpages including website content that is similar to, related to, and/or the same as at least a portion of the corresponding search query 602(1), 602(2), and 602(5) used to generate the search.

With continued reference to FIG. 3, at 314 the processor 202 and/or other hardware or software components of either the electronic device 104 or the service provider 106, such as the framework 228, may identify at least one of the webpage links included in the respective search results 702(1), 702(2), 702(5) as being indicative of a particular webpage that includes the webpage content 402 described above with respect to FIG. 4. In some examples, some search queries 602 may yield search results that are more accurate than other search queries 602. Additionally, for a given search query 602, the accuracy of the webpage links included in the respective search result 702 may also vary greatly. Accordingly, in order to reliably identify at least one of the webpage links included in the respective search results 702(1), 702(2), 702(5) as being indicative of a particular webpage that includes the webpage content 402, the processor 202 and/or other hardware or software components of either the electronic device 104 or the service provider 106 may employ one or more identification rules when analyzing the webpage links included in the respective search results 702(1), 702(2), 702(5). For instance, in some examples the processor 202 and/or other hardware or software components of either the electronic device 104 or the service provider 106 may determine that at least one of the webpage links is included in a greater number of the respective search results 702(1), 702(2), 702(5) than a remainder of the webpage links. In the example search results 700 illustrated in FIG. 7, the webpage link 706 appears in each of the respective search results 702(1), 702(2), 702(5), and thus is included in a greater number of the respective search results 702(1), 702(2), 702(5) than a remainder of the webpage links. In such an example, the processor 202 and/or other hardware or software components of either the electronic device 104 or the service provider 106 may, as a result, identify the particular webpage link 706 at 314 with a relatively high level of confidence.

In some examples, the processor 202 and/or other hardware or software components of either the electronic device 104 or the service provider 106 may determine that each of the webpage links is included in the search results 702 only once. In such examples, the processor 202 and/or other hardware or software components of either the electronic device 104 or the service provider 106 may associate a relatively low level of confidence with each of the search results. In such examples, the processor 202 and/or other hardware or software components of either the electronic device 104 or the service provider 106 may not output and/or otherwise any of the search results or URLs at 314.

In further examples, the processor 202 and/or other hardware or software components of either the electronic device 104 or the service provider 106 may identify the particular webpage link 706 at 314 based at least in part on the title 508 and/or the weight 510 associated with the text groups 506 from which the respective search query 602 has been generated. For example, as noted above the processor 202 and/or other hardware or software components of either the electronic device 104 or the service provider 106 may associate a weight 510 with one or more of the text groups 506 formed at 310. In some examples, such a weight 510 may be based at least in part on a corresponding label 508 associated with the respective text groups 506.

In addition, the processor 202 and/or other hardware or software components of either the electronic device 104 or the service provider 106 may assign a respective score 704 to each webpage link included in the respective search results 702(1), 702(2), 702(5) yielded using corresponding search queries 602(1), 602(2), and 602(5) (i.e., at least a portion of the corresponding recognized text 504). In some examples, each respective score 704 may be indicative of, for example, the degree to which content included on the webpage corresponding to the respective webpage link is similar to and/or matches the respective search query 602 utilized to generate the corresponding internet search. Any scale may be used when assigning such scores 704. Although the scores 704 shown in FIG. 7 are on a scale of 1 to 10, in other examples such a score 704 may employ a scale of 1 to 5, a scale of 1 to 100, and/or any other such scale. In some examples, the scales described herein may be normalized prior to assigning such scores 704. Additionally, the processor 202 and/or other hardware or software components of either the electronic device 104 or the service provider 106 may assign a respective score 704 utilizing one or more text recognition algorithms, syntax analysis algorithms, or other components configured to determine a similarity or relatedness between the search query 602 and the content included on the webpage corresponding to the respective webpage link. In such examples, a relatively high score 704 may be indicative of a relatively high degree of similarity or relatedness between the search query 602 and the content, while conversely, a relatively low score 704 may be indicative of a relatively low degree of similarity or relatedness. For example, as shown in FIG. 7, the particular webpage link 706 may be assigned a high score relative to the other webpage links included in each of the respective search results 702(1), 702(2), 702(5). Such a relatively high score 704 may accurately indicate that the particular webpage link 706 is the source of the original webpage content 402. As a result, in examples in which a score 704 has been assigned to one or more webpage links included in the respective search results 702(1), 702(2), 702(5), the processor 202 and/or other hardware or software components of either the electronic device 104 or the service provider 106 may identify at least one of the webpage links at 314 based at least in part on such scores 704 and, in particular, may identify a particular webpage link 706 based on the score 704 of the webpage link 706 being greater than corresponding scores 704 of a remainder of the webpage links. For example, the processor 202 and/or other hardware or software components of either the electronic device 104 or the service provider 106 may identify the particular webpage link 706 as having the highest score 704 of the search results 702.

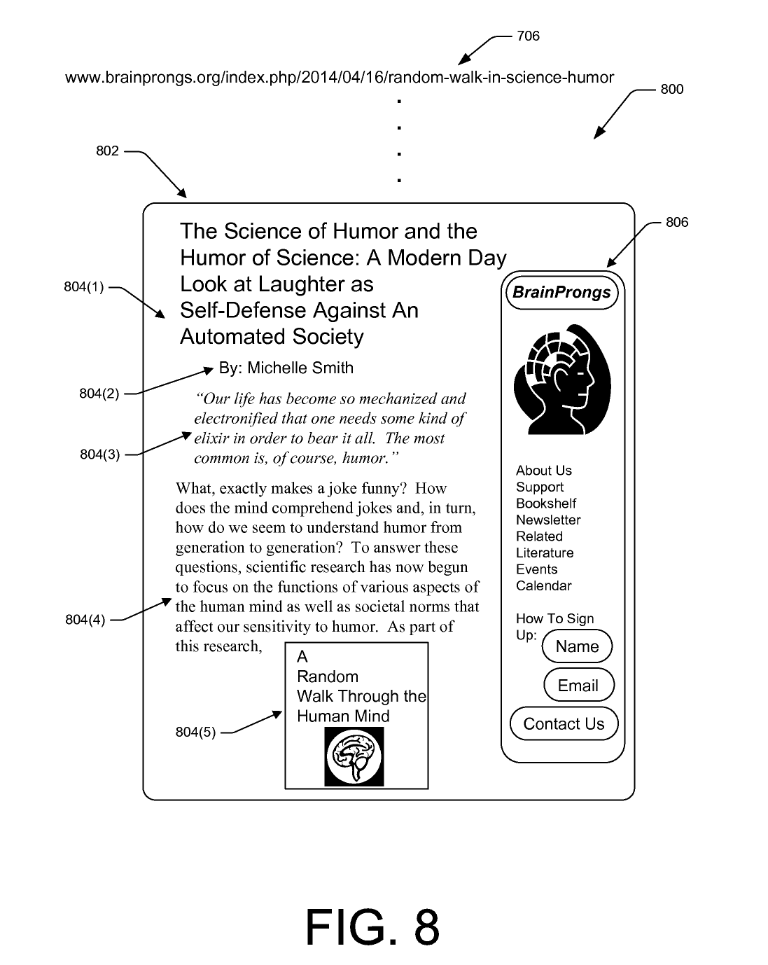

At 316, the processor 202 and/or other hardware or software components of either the electronic device 104 or the service provider 106, such as the framework 228, may generate a content item by extracting various webpage content from a webpage corresponding to the particular webpage link 706. As shown in the example 800 of FIG. 8, at 316 the processor 202 and/or other hardware or software components of either the electronic device 104 or the service provider 106 may visit an example webpage 802 corresponding to the identified webpage link 706. Such an example webpage 802 may include, for example, primary content 804(1), 804(2), 804(3), 804(4), 804(5) (collectively, “primary content 804”) and/or secondary content 806 similar to and/or the same as the primary content 404 and secondary content 406 described above with respect to FIG. 4. For example, primary content 804(1) may comprise a title of the webpage content rendered on the webpage 802, primary content 804(2) may comprise the name of the author of such webpage content, primary content 804(3) and 804(4) may comprise text and/or captions of such webpage content, and the primary content 804(5) may comprise one or more images incorporated within the webpage content rendered on the webpage 802. In some examples, primary content 804 may comprise content that is positioned between the “<body><body>” tags in a webpage, or other content that is related to such content. The secondary content 806, on the other hand, may comprise one or more advertisements, toolbars, headers, footers, hotlinks, and/or other webpage content rendered on the webpage 802. As noted above with respect to FIG. 4, such secondary content 806 may be ancillary to (i.e., less important to the user 102 than) the primary content 804.

In some examples, at 316 the processor 202 and/or other hardware or software components of either the electronic device 104 or the service provider 106 may generate a content item by extracting at least a portion of the primary content 804 from the webpage 802 and by omitting at least a portion of the secondary content 806 of the webpage 802. In performing such operations at 316, the processor 202 and/or other hardware or software components of either the electronic device 104 or the service provider 106 may employ one or more text recognition algorithms, syntax analysis algorithms, and/or other hardware or software components to distinguish the primary content 804 from the secondary content 806 such that, in some examples, only the primary content 804 may be utilized to generate the content item. For example, such text recognition algorithms, syntax analysis algorithms, and/or other hardware or software components may include, among other things, Microsoft® extractor software (Microsoft Corporation®, Redmond, Wash.) as included in Microsoft Windows® 8.11E11 and Microsoft Windows Phone® 8.1 IE11. In further examples in which alternate operating systems (e.g., OSX™ or LINUX™) are employed, alternative compatible extractor applications may be employed. In some examples, the text recognition algorithms, syntax analysis algorithms, and/or other hardware software components utilized at 316 to generate the content item may be configured to extract such primary content 804 from various websites 802 in order to generate, for example, a content item configured for viewing in alternate formats such as via a wireless phone, tablet, PDA, or other electronic device 104.

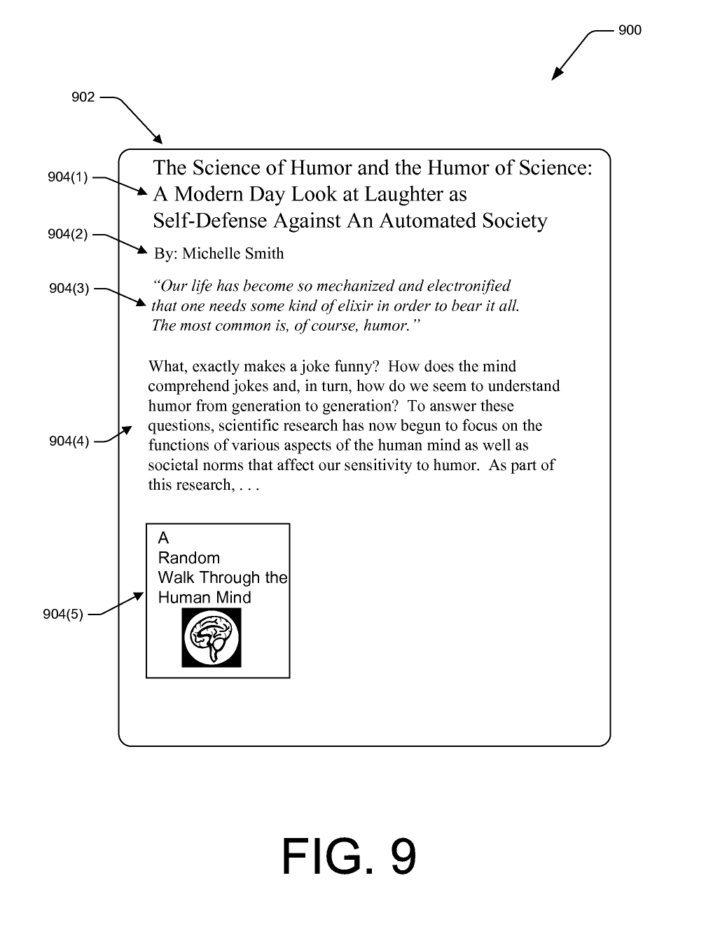

FIG. 9 illustrates an example 900 in which a content item 902 has been generated at 316. In particular, the content item 902 has been generated by extracting the primary content 804 from the webpage 802 corresponding to the webpage link 706, and by omitting the secondary content 806 included in the webpage 802. Such an extracted content item 902 may be configured for adaptive rendering on, for example, a display 208 of any of the electronic devices 104 described above. As shown in FIG. 9, an example content item 902 comprises a modified version of the webpage content 402 described above with respect to FIG. 4. In particular, the content item 902 may be formatted and/or otherwise configured such that the content item 902 may be easily consumed by the user 102 when rendered on the display 208 of one of the electronic devices 104. For example, the content item 902 may include primary content 904(1), 904(2), 904(3), 904(4), 904(5) (collectively, “primary content 904”) that is substantially similar to and/or the same as the primary content 804 of the webpage 802 corresponding to the webpage link 706. In some examples, however, the font size, font type, line spacing, margins, and/or other characteristics of the primary content 904 may be standardized such that the content item 902 can be rendered on the various electronic devices 104 efficiently. For example, the primary content 804(1) of the webpage 802 comprises text (e.g., a title) having a font type (e.g., Arial) that is different from a font type (Times New Roman) of the majority of a remainder the primary content 804. In such examples, the corresponding primary content 904(1) of the content item 902 may comprise the font type (Times New Roman) of the majority of a remainder the primary content 804. Additionally, the primary content 804(2) of the webpage 802 comprises text (e.g., an author name) having a font type (e.g., Arial) and a left-hand margin that are different from a font type (Times New Roman) and a left-hand margin of the majority of a remainder the primary content 804. In such examples, the corresponding primary content 904(2) of the content item 902 may comprise the font type (Times New Roman) and a left-hand margin of the majority of a remainder the primary content 804. In some examples, standardizing the content item 902 in this way may assist the user 102 in consuming the content item 902 on one or more of the electronic devices 104.

In some examples, the electronic device 104 may receive a request for the primary content 404 of the webpage content 402 shown in FIG. 4. In such examples, such a request may be received from, for example, a user 102 of the electronic device 104. In particular, such a request may result from a desire of the user to view, for example, webpage content 402 that has previously been rendered by the display 208. As described above with respect to the electronic device 104, such a request may comprise, for example, one or more such inputs received via the display 208 and/or other inputs received on the electronic device 104 via one or more additional I/O interfaces 204 or I/O devices 206.

In some examples, the content item 902 may be generated, at 316, by either the processor 202 of the electronic device 104 or by the service provider 106. In examples in which the content item 902 is generated by the processor 202 of the electronic device 104, such a content item 902 may be, for example, saved in the CRM 220 at 316. Thus, the electronic device 104 may, in response to receiving the request described above, retrieve the content item 902 from the CRM 220 and render the content item 902 on the display 208. In examples in which the content item 902 is generated by one or more processors and/or other components of the service provider 106 at 316, such a content item 902 may be, for example, saved in a memory of the service provider 106 at 316. In such examples, the electronic device 104 may, in response to receiving the request from the user 102, send a signal, message, and/or request to the service provider 106, via the network 108. In such examples, a signal sent by the electronic device 104 to the service provider 106 may include information requesting, among other things, a digital copy of the content item 902 generated by the service provider 106. In response to receiving such a signal from the electronic device 104, the service provider 106 may provide a copy of the content item 902 to the electronic device 104 via the network 108. In some examples, the electronic device 104 may render the content item 902 on the display 208 in response to receiving the content item 902 from the service provider 106.

Examples of the present disclosure may be utilized by various users 102 wishing to retrieve content viewed by the user from a plurality of different webpages or other sources. For example, it is common for users 102 to consume content on electronic devices 104 from a variety of different webpages, and using a variety of different and unrelated applications to do so. For example, such content may be viewed using different news applications, blog applications, social media applications, and/or other applications having a variety of different formats. Examples of the present disclosure enable the user 102 to save images (i.e., screenshots) from each of these different applications, regardless of application type. Thus, examples of the present disclosure comprise a universal framework configured to enable users 102 to save content having various different formats and originating from various different sources (i.e., regardless of the type, format, and/or source of the content). Such examples also enable the user 102 to recall the underlying content included in such saved images for consumption later in time. Additionally, since the underlying content is to be consumed via the electronic device 104, examples of the present disclosure may provide the underlying content to the user 102 in a modified format that is more easily and effectively rendered on the display 208 for consumption by the user 102.

Examples of the present disclosure may provide multiple technical benefits to the electronic device 104, the service provider 106, and/or the network 108. For instance, traffic on the network 108 may be reduced in examples of the present disclosure since users 102 will not need to submit multiple searches in an effort to find the content they had previously viewed. Additionally, since the electronic device 104 and/or the service provider 106 may save screenshots of content having various different formats and originating from various different sources, multiple different applications need not be employed by the electronic device 104 and/or the service provider 106 to recover webpages including the desired content. Since multiple applications are not needed, storage space in the CRM as well as processor resources may be maximized. As a result, examples of the present disclosure may improve the overall user experience.

Clause 1: In some examples of the present disclosure, a method includes receiving a captured image with a device, wherein the image is received by the device via a network and the captured image includes webpage content. The method also includes recognizing, using optical character recognition, text included in the image, forming a plurality of text groups based on the text included in the image, and generating a plurality of searches. In such a method, each search of the plurality of searches uses text from a respective text group as a search query, and yields a respective search result including at least one webpage link. Such a method also includes identifying at least one of the webpage links as being indicative of a webpage that includes the webpage content, generating a content item using the webpage content from the webpage, and providing access to the content item via the network.

Clause 2: The method of clause 1, wherein forming the plurality of text groups includes grouping adjacent lines of text sharing a common contextual relationship, and associating a label with at least one text group of the plurality of text groups, wherein the label identifies the common contextual relationship associated with the at least one text group.

Clause 3: The method of clause 1 or 2, wherein the image includes a screenshot captured while rendering the webpage content, the method further including saving the screenshot in memory associated with the device.

Clause 4: The method of clause 1, 2, or 3, further comprising receiving a request via the network, and sending the content item, via the network, in response to the request.

Clause 5: The method of clause 1, 2, 3, or 4, wherein at least one search seed includes text from a first text group and text from a second text group different from the first text group.

Clause 6: The method of clause 1, 2, 3, 4, or 5, wherein forming the plurality of text groups includes grouping adjacent text lines having respective widths that are approximately equal.

Clause 7: The method of clause 1, 2, 3, 4, 5, or 6, wherein forming the plurality of text groups includes grouping adjacent text lines having approximately equal vertical spacing between the text lines.

Clause 8: The method of clause 1, 2, 3, 4, 5, 6, or 7, wherein forming the plurality of text groups includes grouping adjacent text lines having respective margins that are approximately equal.

Clause 9: The method of clause 1, 2, 3, 4, 5, 6, 7, or 8, further including determining that at least one text group of the plurality of text groups has a number of words less than a minimum word threshold, and omitting the at least one text group from the plurality of searches based at least in part on determining that at least one text group of the plurality of text groups has the number of words less than the minimum word threshold.

Clause 10: The method of clause 1, 2, 3, 4, 5, 6, 7, 8, or 9, wherein identifying the at least one of the webpage links includes determining that the at least one of the webpage links is included in a greater number of the respective search results than a remainder of the webpage links.

Clause 11: The method of clause 1, 2, 3, 4, 5, 6, 7, 8, 9, or 10, further including associating a label with at least one text group of the plurality of text groups, the label including one of title, author, date, text, or source.

Clause 12: The method of clause 1, 2, 3, 4, 5, 6, 7, 8, 9, 10, or 11, further including omitting the at least one text group from the plurality of searches based at least in part on the label associated with the at least one text group.

Clause 13: The method of clause 1, 2, 3, 4, 5, 6, 7, 8, 9, 10, 11, or 12, further including: associating a weight with the at least one text group of the plurality of text groups based at least in part on the label associated with the at least one text group; assigning a score to each webpage link included in the respective search result yielded using text from the at least one text group; and identifying the at least one of the webpage links based at least in part on the scores.

Clause 14: A method includes receiving a screenshot of webpage content; saving the screenshot in memory associated with a processor; recognizing, using optical character recognition, text included in the saved screenshot; generating a plurality of search queries using the text recognized using optical character recognition; and causing at least one search to be performed using the plurality of search queries. Such a method also includes receiving a search result corresponding to the at least one search, the search result including at least one webpage link; identifying the at least one webpage link as being indicative of a webpage that includes the webpage content; and generating a content item by extracting the webpage content from the webpage.

Clause 15: The method of clause 14, further including receiving a request for the webpage content, and providing the content item, via a network associated with the device, in response to the request, wherein the content item is configured to be rendered on an electronic device.

Clause 16: The method of clause 14 or 15, further including forming a plurality of text groups with the text recognized using optical character recognition, wherein each group of the plurality of text groups is formed based on at least one shared characteristic of adjacent text lines in the screenshot of webpage content.

Clause 17: The method of clause 16, further including: identifying a first set of groups of the plurality of text groups having a number of words greater than or equal to a minimum word threshold; identifying a second set of groups of the plurality of text groups having a number of words less than the minimum word threshold; and generating the plurality of search queries using text from the first set of groups and omitting text from the second set of groups.

Clause 18: The method of clause 16, further including: assigning a weight to each group of the plurality of text groups; assigning a score to the at least one webpage link, wherein the score is based at least in part on a corresponding weight; and identifying the at least one webpage link based at least in part on the score.

Clause 19: A device includes a processor, wherein the device is configured to receive a screenshot of webpage content from an electronic device remote from the device, the device configured to: recognize, using optical character recognition, text included in the screenshot; generate a plurality of search queries using the text recognized using optical character recognition; cause at least one search to be performed; receive a search result corresponding to the at least one search, the search result including at least one webpage link; identify the at least one link as being indicative of a webpage that includes the webpage content; and generate a content item by extracting content from the webpage, wherein the content item comprises a modified version of the webpage content and is configured to be rendered on a display associated with the electronic device.

Clause 20: The device of clause 19, further comprising memory disposed remote from the electronic device, the memory configured to store the screenshot and the content item.

Clause 21: The device of clause 19 or 20, wherein the device is further configured to cause a plurality of searches to be performed, wherein each search of the plurality of searches is performed by a different respective search engine.

The architectures and individual components described herein may include many other logical, programmatic, and physical components, of which those shown in the accompanying figures are merely examples that are related to the discussion herein.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

### CONCLUSION

Although the various examples have been described in language specific to structural features and/or methodological acts, the disclosure is not necessarily limited to the specific features or acts described. Rather, the specific features and acts are disclosed as example forms of implementing the claimed subject matter.

What is claimed is:

1. A method, comprising:
receiving a captured image with a device, wherein the image is received by the device via a network and the captured image includes webpage content;
recognizing, using optical character recognition, text included in the image;
forming a plurality of text groups based on the text included in the image;
generating a plurality of searches, wherein each search of the plurality of searches:
uses text from a respective text group as a search query, and
yields a respective search result including at least one webpage link;
identifying at least one of the webpage links as being indicative of a webpage that includes the webpage content;
generating a content item using the webpage content from the webpage; and
providing access to the content item via the network.

2. The method of claim 1, wherein forming the plurality of text groups includes grouping adjacent lines of text sharing a common contextual relationship, and associating a label with at least one text group of the plurality of text groups, wherein the label identifies the common contextual relationship associated with the at least one text group.

3. The method of claim 1, wherein the image includes a screenshot captured while rendering the webpage content, the method further including saving the screenshot in memory associated with the device.

4. The method of claim 1, further comprising receiving a request via the network, and sending the content item, via the network, in response to the request.

5. The method of claim 1, wherein at least one search seed includes text from a first text group and text from a second text group different from the first text group.

6. The method of claim 1, wherein forming the plurality of text groups includes grouping adjacent text lines having respective widths that are approximately equal.

7. The method of claim 1, wherein forming the plurality of text groups includes grouping adjacent text lines having approximately equal vertical spacing between the text lines.

8. The method of claim 1, wherein forming the plurality of text groups includes grouping adjacent text lines having respective margins that are approximately equal.

9. The method of claim 1, further including determining that at least one text group of the plurality of text groups has a number of words less than a minimum word threshold, and omitting the at least one text group from the plurality of searches based at least in part on determining that at least one text group of the plurality of text groups has the number of words less than the minimum word threshold.

10. The method of claim 1, wherein identifying the at least one of the webpage links includes determining that the at least one of the webpage links is included in a greater number of the respective search results than a remainder of the webpage links.

11. The method of claim 1, further including associating a label with at least one text group of the plurality of text groups, the label including one of title, author, date, text, or source.

12. The method of claim 11, further including omitting the at least one text group from the plurality of searches based at least in part on the label associated with the at least one text group.

13. The method of claim 11, further including:
associating a weight with the at least one text group of the plurality of text groups based at least in part on the label associated with the at least one text group;
assigning a score to each webpage link included in the respective search result yielded using text from the at least one text group; and
identifying the at least one of the webpage links based at least in part on the scores.

14. A method, comprising:
receiving a screenshot of webpage content;
saving the screenshot in memory associated with a processor;
recognizing, using optical character recognition, text included in the saved screenshot;
generating a plurality of search queries using the text recognized using optical character recognition;
causing at least one search to be performed using the plurality of search queries;
receiving a search result corresponding to the at least one search, the search result including at least one webpage link;
identifying the at least one webpage link as being indicative of a webpage that includes the webpage content; and
generating a content item by extracting the webpage content from the webpage.

15. The method of claim 14, further including receiving a request for the webpage content, and providing the content item, via a network associated with the device, in response to the request, wherein the content item is configured to be rendered on an electronic device.

16. The method of claim 14, further including forming a plurality of text groups with the text recognized using optical character recognition, wherein each group of the plurality of text groups is formed based on at least one shared characteristic of adjacent text lines in the screenshot of webpage content.

17. The method of claim 16, further including:
identifying a first set of groups of the plurality of text groups having a number of words greater than or equal to a minimum word threshold;
identifying a second set of groups of the plurality of text groups having a number of words less than the minimum word threshold; and
generating the plurality of search queries using text from the first set of groups and omitting text from the second set of groups.

18. The method of claim 16, further including:
assigning a weight to each group of the plurality of text groups;
assigning a score to the at least one webpage link, wherein the score is based at least in part on a corresponding weight; and
identifying the at least one webpage link based at least in part on the score.

19. A device, comprising:
a processor, wherein the device is configured to receive a screenshot of webpage content from an electronic device remote from the device, the device configured to:
recognize, using optical character recognition, text included in the screenshot;
generate a plurality of search queries using the text recognized using optical character recognition;
cause at least one search to be performed;
receive a search result corresponding to the at least one search, the search result including at least one webpage link;
identify the at least one link as being indicative of a webpage that includes the webpage content; and
generate a content item by extracting content from the webpage, wherein the content item comprises a modified version of the webpage content and is configured to be rendered on a display associated with the electronic device.

20. The device of claim 19, further comprising memory disposed remote from the electronic device, the memory configured to store the screenshot and the content item.

21. The device of claim 19, wherein the device is further configured to cause a plurality of searches to be performed, wherein each search of the plurality of searches is performed by a different respective search engine.
